(19) United States
(12) Patent Application Publication
(10) Pub. No.: US 2005/0069779 A1
(43) Pub. Date: Mar. 31, 2005

(54) Lithium secondary battery

(76) Inventors: Seiji Yoshimura, Kobe-city (JP); Naoki Imachi, Kobe-city (JP); Keiji Saishou, Kobe-city (JP); Masanobu Takeuchi, Kobe-city (JP); Yasuo Takano, Kobe-city (JP)

Correspondence Address: KUBOVCIK & KUBOVCIK, SUITE 710, 900 17TH STREET NW, WASHINGTON, DC, 20006, US

(21) Appl. No.: 10/947,325

(22) Filed: Sep. 23, 2004

(30) Foreign Application Priority Data
Sep. 25, 2003 (JP) 2003-333650

(51) Int. Cl. H01M 2/16; H01M 4/40; H01M 10/40

(52) U.S. Cl. 429/247; 429/231.95; 429/224; 429/324

(57) ABSTRACT

A lithium secondary battery including a positive electrode, a negative electrode which is a lithium-aluminum alloy, a separator of a glass fiber including SiO₂, B₂O₃ and Na₂O, and a nonaqueous electrolyte including a solute and a solvent. The lithium secondary battery has excellent battery characteristics after a reflow treatment.

### FIELD OF THE INVENTION

The present invention relates to a lithium secondary battery for use as a power source for memory back-up.

### BACKGROUND OF THE INVENTION

A lithium secondary battery has been used as a power source for memory back-up for compact size portable equipment. In such a battery, a lead terminal of the battery is soldered to a printed circuit board by automatic soldering by a reflow method. Temperature in a reflow furnace is about 250° C. Therefore, the lithium secondary battery soldered by the reflow method must be heat-resistant. Components of the battery also must be heat-resistant.

Japanese Patent Laid-open Publication No. 2000-40525 discloses a separator made of polyphenylene sulfide as well as the use of a heat-resistant electrolyte in a battery used in a reflow method.

However, a conventional lithium secondary battery has problems that a negative electrode and a separator react during reflow treatment and battery characteristics after reflow are not satisfactory.

### OBJECT OF THE INVENTION

An object of the present invention is to provide a lithium secondary battery having excellent battery characteristics after a reflow treatment.

### SUMMARY OF THE INVENTION

A lithium secondary battery of the present invention comprises a positive electrode, a negative electrode which is a lithium-aluminum alloy, a separator comprising a glass fiber including SiO₂, B₂O₃ and Na₂O, and a nonaqueous electrolyte comprising a solute and a solvent.

In the present invention, a glass fiber including SiO₂, B₂O₃ and Na₂O is used as the separator, and a lithium-aluminum alloy is used as the negative electrode. Components of the glass fiber and aluminum in the lithium-aluminum alloy alloy to form a film comprising an aluminum-glass fiber component having ion conductivity on the negative electrode. The film suppresses a reaction between the negative electrode and the electrolyte and battery characteristics are excellent even after reflow.

### BRIEF DESCRIPTION OF THE DRAWINGS

FIG. 1 is a cross section of a battery as prepared in the Examples.

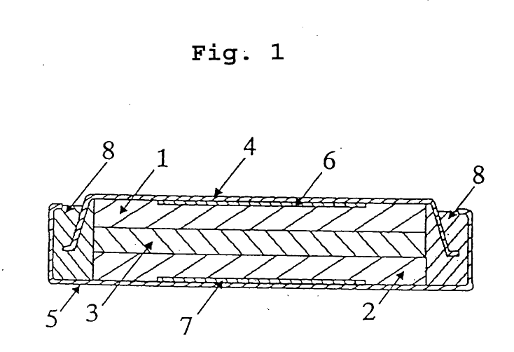

[Explanation of Elements]

1: negative electrode

2: positive electrode

3: separator

4: negative electrode can

5: positive electrode can

6: negative electrode current collector

7: positive electrode current collector

8: insulation packing

### DETAILED EXPLANATION OF THE INVENTION

The separator of the lithium secondary battery of the present invention is preferably madse of a glass fiber comprising 40˜94 weight % SiO₂, 3˜30 weight % B₂O₃ and 3˜30 weight % Na₂O. When a ratio of SiO₂, B₂O₃ and Na₂O is in this range, an aluminum-glass fiber component is deposited on the negative electrode and a film having high ion conductivity is formed thereon and a lithium secondary battery having excellent battery characteristics after reflow treatment is provided.

The lithium-aluminum alloy used for the negative electrode can be obtained by, for example, electrochemical insertion of lithium into an aluminum alloy. A lithium-aluminum-manganese alloy is preferred as the lithium-aluminum alloy. When the lithium-aluminum-manganese alloy is used, an aluminum-manganese-glass component film having especially high ion conductivity can be formed on the negative electrode by deposition to provide a lithium secondary battery having excellent battery characteristics after reflow treatment.

The lithium-aluminum-manganese alloy used for the negative electrode can be obtained by, for example, electrochemical insertion of lithium into an aluminum-manganese alloy. The manganese content in the aluminum-manganese alloy is preferably in a range of 0.1˜10 weight %. If the content is in this range, an aluminum-manganese-glass fiber component film having especially high ion conductivity is formed on the negative electrode and a lithium secondary battery having excellent battery characteristics after reflow treatment is provided.

The nonaqueous electrolyte comprises a solute and a solvent. As the solute, lithium perfluoroalkylsulfonyl imide is especially preferred. When the lithium perfluoroalkylsulfonyl imide is used, a lithium secondary battery having excellent battery characteristics after reflow is provided. It is believed that a film containing the solute component and having a high ionic conductivity is formed on the negative electrode to provide a battery having excellent battery characteristics.

Lithium perfluoroalkylsulfonyl imide can be used alone or in combination with other solutes. There are no limitations with respect to the other solute to be used for the nonaqueous electrolyte if the solute is useful for a lithium secondary battery. Lithium hexafluorophosphate, lithium tetrafluoroborate, lithium hexafluoroarsenate, lithium perchlorate, lithium polyfluoromethanesulfonate, lithium trisperfluoroalkyl methide, and the like can be illustrated. When more than two solutes are used, lithium perfluoroalkylsulfonyl imide is preferably at least 50 mol % of the solutes.

Polyethylene glycol dialkyl ether is preferably used as the solvent. When such solvent is used, a film containing the aluminum-glass fiber component or aluminum-manganese-glass fiber component and having a high ionic conductivity is formed on the negative electrode to provide a battery having excellent battery characteristics after reflow treatment.

Polyethylene glycol dialkyl ether can be used alone or in combination with other solvents. A carbonate, for example, diethylene carbonate, propylene carbonate, and the like, an ether, for example, 1,2-dimethoxyethane, 1,2-diethoxyethane, and the like, can be illustrated as other solvents. When polyethylene glycol dialkyl ether is mixed with another solvent, polyethylene glycol dialkyl ether is preferably at least 50% by volume of the solvents.

### EFFECTS OF THE INVENTION

A reaction of a negative electrode and an electrolyte can be suppressed during reflow treatment according to the present invention. A lithium secondary battery having excellent battery characteristics after reflow treatment can be provided.

### DESCRIPTION OF PREFERRED EMBODIMENT

Embodiments of the present invention are explained in detail below. It is of course understood that the present invention is not limited to the batteries described in the following examples, but can be modified within the scope and spirit of the appended claims.

### EXAMPLE 1

### Example 1-1

[Preparation of Positive Electrode]

Lithium manganese oxide (LiMn₂O₄) powder having a spinel structure, carbon black powder as a conductive agent and a fluororesin powder as a binding agent were mixed in a ratio by weight of 85:10:5 to prepare a positive electrode mixture. The positive electrode mixture was fabricated into a disc by foundry molding, and was dried at 250° C. for 2 hours under vacuum to prepare a positive electrode.

[Preparation of Negative Electrode]

Lithium was electrochemically inserted into an aluminum-manganese alloy (the manganese content based on the total weight of aluminum and manganese was 1 weight %) to prepare a lithium-aluminum-manganese alloy (Li—Al—Mn). The lithium-aluminum-manganese alloy was punched out into a disc to prepare a negative electrode.

[Preparation of Nonaqueous Electrolyte]

Lithium bis(trifluoromethylsulfonyl)imide (LiN(CF₃SO₂)₂) as a solute was dissolved in, as a nonaqueous solvent, diethylene glycol dimethyl ether (Di-DME) to a concentration of 1 mol/l to prepare a nonaqueous electrolyte.

[Assembly of Battery]

A flat (coin-shaped) lithium secondary battery Al of the present invention having an outer diameter of 24 mm and a thickness of 3 mm was assembled using the above-prepared positive and negative electrodes and the nonaqueous electrolyte. A non-woven fabric of glass fibers including SiO₂ (70 weight %), B₂O₃ (15 weight %) and Na₂O (15 weight %) was used as a separator. The separator was impregnated with the nonaqueous electrolyte.

The battery Al comprised the negative electrode 1, positive electrode 2, the separator 3 placed between the positive electrode 2 and negative electrode 1, a negative electrode can 4, a positive electrode can 5, a negative electrode current collector 6 comprising stainless steel (SUS304), a positive electrode current collector 7 comprising stainless steel (SUS316) and an insulation packing 8 comprising polyphenylsulfide.

The separator 3 was placed between the negative electrode 1 and positive electrode 2 and was placed in a battery case comprising positive electrode can 5 and negative electrode can 4. The positive electrode 2 was connected to the positive electrode can 5 through the positive electrode current collector 7. The negative electrode 1 was connected to the negative electrode can 4 through the negative electrode current collector 6. Chemical energy generated in the battery can be taken outside as electrical energy through terminals of the positive can 5 and the negative can 4.

### Example 1-2

A battery A2 of the present invention was prepared in the same manner as in Example 1-1 except that a non-woven fabric of glass fibers including SiO₂ (67 weight %), B₂O₃ (30 weight %) and Na₂O (3 weight %) was used as a separator.

### Example 1-3

A battery A3 of the present invention was prepared in the same manner as in Example 1-1 except that a non-woven fabric of glass fibers including SiO₂ (67 weight %), B₂O₃ (3 weight %) and Na₂O (30 weight %) was used as a separator.

### Example 1-4

A battery A4 of the present invention was prepared in the same manner as in Example 1-1 except that a non-woven fabric of glass fibers including SiO₂ (65 weight %), B₂O₃ (29 weight %), Na₂O (3 weight %) and K₂O (3 weight %) was used as a separator.

### Example 1-5

A battery A5 of the present invention was prepared in the same manner as in Example 1-1 except that a non-woven fabric of glass fibers including SiO₂ (65 weight %), B₂O₃ (29 weight %), Na₂O (3 weight %) and CaO (3 weight %) was used as a separator.

### Example 1-6

A battery A6 of the present invention was prepared in the same manner as in Example 1-1 except that a non-woven fabric of glass fibers including SiO₂ (63 weight %), B₂O₃ (28 weight %), Na₂O (3 weight %), K₂O (3 weight %) and CaO (3 weight %) as used as a separator.

### Comparative Example 1-1

A comparative battery X1 was prepared in the same manner as in Example 1-1 except that a non-woven fabric of polypropylene fibers was used as a separator.

### Comparative Example 1-2

A comparative battery X2 was prepared in the same manner as in Example 1-1 except that a non-woven fabric of polyethylene fibers was used as a separator.

### Comparative Example 1-3

A comparative battery X3 was prepared in the same manner as in Example 1-1 except that a non-woven fabric of polyphenylsulfide fabric was used as a separator.

### Comparative Example 1-4

A battery X4 of the present invention was prepared in the same manner as in Example 1-1 except that a non-woven fabric of glass fibers including SiO₂ (69 weight %) and B₂O₃ (31 weight %) was used as a separator.

### Comparative Example 1-5

A battery X4 of the present invention was prepared in the same manner as in Example 1-1 except that a non-woven fabric of glass fibers including SiO₂ (69 weight %) and Na₂O (31 weight %) was used as a separator.

### Comparative Example 1-6

A comparative battery X6 was prepared in the same manner as in Example 1-1 except that lithium metal was used instead of the lithium-aluminum-manganese alloy (Li—Al—Mn).

### Comparative Example 1-7

A comparative battery X7 was prepared in the same manner as in Example 1-1 except that a mixture of 95 weight parts of natural graphite powder and 5 weight parts of polyvinylidene fluoride powder was used to prepare a negative electrode mixture.

### Comparative Example 1-8

A comparative battery X8 was prepared in the same manner as in Example 1-1 except that a mixture of 90 weight parts of tin oxide (SnO) powder, 5 weight parts of carbon powder and 5 weight parts of polyvinylidene fluoride powder was used to prepare a negative electrode mixture.

### Comparative Example 1-9

A comparative battery X9 was prepared in the same manner as in Example 1-1 except that a mixture of 90 weight parts of silicon oxide (SiO) powder, 5 weight parts of carbon powder and 5 weight parts of polyvinylidene fluoride powder was used to prepare a negative electrode mixture.

[Measurement of Battery Characteristics after Reflow]

Immediate after preparation of the batteries, the batteries were preheated at 200° C. for one minute, were passed for one minute through a reflow furnace in which the highest temperature was 300° C. and the lowest temperature was 200° C. close to the entrance and exit of the furnace, respectively, and internal resistance of each battery was measured (internal resistance after reflow treatment)

The results are shown in Table 1.

TABLE 1

| | | Internal | |
|---|---|---|---|
| | | Resistance | |
| | Negative | after | |
| Separator (wt %) | Electrode | Reflow (Ω) | Battery |
| Glass fiber (SiO₂(70), B₂O₃(15) | Li—Al—Mn | 83 | A1 |
| and Na₂O(15)) | Alloy | | |
| Glass fiber (SiO₂(67), B₂O₃(30) | Li—Al—Mn | 85 | A2 |
| and Na₂O(3)) | Alloy | | |
| Glass fiber (SiO₂(67), B₂O₃(3) | Li—Al—Mn | 88 | A3 |
| and Na₂O(30)) | Alloy | | |
| Glass fiber (SiO₂(65), B₂O₃(29), | Li—Al—Mn | 91 | A4 |
| Na₂O(3) and K₂O(3)) | Alloy | | |
| Glass fiber (SiO₂(65), B₂O₃(29), | Li—Al—Mn | 95 | A5 |
| Na₂O(3) and CaO(3)) | Alloy | | |
| Glass fiber (SiO₂(63), B₂O₃(28), | Li—Al—Mn | 97 | A6 |
| Na₂O(3), K₂O(3) and CaO(3)) | Alloy | | |
| Polypropylene fiber | Li—Al—Mn | 850 | X1 |
| | Alloy | | |
| Polyethylene fiber | Li—Al—Mn | 880 | X2 |
| | Alloy | | |
| Polyphenylene sulfide fiber | Li—Al—Mn | 190 | X3 |
| | Alloy | | |
| Glass fiber (SiO₂(69) and | Li—Al—Mn | 210 | X4 |
| B₂O₃(31)) | Alloy | | |
| Glass fiber (SiO₂(69) and | Li—Al—Mn | 220 | X5 |
| Na₂O(31)) | Alloy | | |
| Glass fiber (SiO₂(70), B₂O₃(15) | Lithium | 710 | X6 |
| and Na₂O(15)) | metal | | |
| Glass fiber (SiO₂(70), B₂O₃(15) | Li- | 260 | X7 |
| and Na₂O(15)) | natural | | |
| | graphite | | |
| Glass fiber (SiO₂(70), B₂O₃(15) | Li—SnO | 290 | X8 |
| and Na₂0(15)) | | | |
| Na | | | |
| Glass fiber (SiO₂(70), B₂O₃(15) | Li—SiO | 280 | X9 |
| and Na₂O(15)) | | | |

As is clear from the results shown in Table 1, the internal resistance of batteries A1˜A6 of the present invention is lower than that of the batteries of the Comparative Examples. It is believed that aluminum included in the negative electrode and the glass component of the separator were alloyed and a film comprising an aluminum-glass component having ionic conductivity was formed.

### EXAMPLE 2

### Example 2-1

A battery B1 of the present invention was prepared in the same manner as in Example 1-1 except that aluminum was used instead of an aluminum-manganese alloy having a manganese content of 1 weight %.

### Example 2-2

A battery B2 of the present invention was prepared in the same manner as in Example 1-1 except that an aluminum-manganese alloy having a manganese content of 0.1 weight % was used instead of an aluminum-manganese alloy having a manganese content of 1 weight %.

### Example 2-2

A battery B3 of the present invention was prepared in the same manner as in Example 1-1 except that an aluminum-manganese alloy having a manganese content of 0.5 weight % was used instead of an aluminum-manganese alloy having a manganese content of 1 weight %.

### Example 2-3

A battery B4 of the present invention was prepared in the same manner as in Example 1-1 (battery B4 is the same as battery A1).

### Example 2-5

A battery B5 of the present invention was prepared in the same manner as in Example 1-1 except that an aluminum-manganese alloy having a manganese content of 5 weight % was used instead of an aluminum-manganese alloy having a manganese content of 1 weight %.

### Example 2-6

A battery B6 of the present invention was prepared in the same manner as in Example 1-1 except that an aluminum-manganese alloy having a manganese content of 10 weight % was used instead of an aluminum-manganese alloy having a manganese content of 1 weight %.

Internal resistance after reflow treatment of the batteries prepared above was measured in the same manner as in Example 1. The results are shown in Table 2.

TABLE 2

| Mn Ratio in | Internal Resistance after | |
|---|---|---|
| Al—Mn (wt %) | Reflow (Ω) | Battery |
| 0 | 100 | B1 |
| 0.1 | 94 | B2 |
| 0.5 | 85 | B3 |
| 1 | 83 | B4(A1) |
| 5 | 85 | B5 |
| 10 | 95 | B6 |

As shown in Table 2, batteries B2˜B6 of present wherein the aluminum alloy is an aluminum-manganese alloy have smaller internal resistance as compared to battery B1. It is concluded from these results that the aluminum-manganese alloy is preferable as the aluminum alloy. The manganese content of the aluminum-manganese alloy is preferably in a range of 0.1˜10 weight %, and more preferably in a range of 0.5˜5 weight %.

### EXAMPLE 3

### Example 3-1

A battery C1 was prepared in the same manner as in Example 1-1 (battery A1).

### Example 3-2

A battery C2 of the present invention was prepared in the same manner as in Example 1-1 except that lithium (trifluoromethylsulfonyl)(pentafluoroethylsulfonyl)imide (LiN(CF₃SO₂) (C₂F₅SO₂)) was used as the solute in the nonaqueous electrolyte.

### Example 3-3

A battery C3 of the present invention was prepared in the same manner as in Example 1-1 except that lithium bis(pentafluoroethylsulfonyl) imide (LiN(C₂F₅SO₂)₂) was used as the solute in the nonaqueous electrolyte.

### Example 3-4

A battery C4 of the present invention was prepared in the same manner as in Example 1-1 except that lithium tris(trifluoromethylsulfonyl) methide (LiC(CF₃SO₂)₃) was used as the solute in the nonaqueous electrolyte.

### Example 3-5

A battery C5 of the present invention was prepared in the same manner as in Example 1-1 except that lithium trifluoromethanesulfonate (LiCF₃SO₃) was used as the solute in the nonaqueous electrolyte.

### Example 3-6

A battery C6 of the present invention was prepared in the same manner as in Example 1-1 except that lithium hexafluorophosphate (LiPF₆) was used as the solute in the nonaqueous electrolyte.

### Example 3-7

A battery C7 of the present invention was prepared in the same manner as in Example 1-1 except that lithium tetrafluoroborate (LiBF₄) was used as the solute in the nonaqueous electrolyte.

### Example 3-8

A battery C8 of the present invention was prepared in the same manner as in Example 1-1 except that lithium hexafluoroarsenate (LiAsF₆) was used as the solute in the nonaqueous electrolyte.

### Example 3-9

A battery C9 of the present invention was prepared in the same manner as in Example 1-1 except that lithium perchlorate (LiClO₄) was used as the solute in the nonaqueous electrolyte.

Internal resistance after reflow of the batteries prepared above was measured in the same manner as in Example 1. The results are shown in Table 3.

TABLE 3

| | Internal Resistance | |
|---|---|---|
| Solute (1 M) | after Reflow (Ω) | Battery |
| LiN(CF₃SO₂)₂ | 83 | C1(A1) |
| LiN(CF₃SO₂) (C₂F₅SO₂) | 85 | C2 |
| LiN(C₂F₅SO₂)₂ | 91 | C3 |
| LiC(CF₃SO₂)₃ | 100 | C4 |
| LiCF₃SO₃ | 98 | C5 |
| LiPF₆ | 120 | C6 |
| LiBF₄ | 140 | C7 |
| LiAsF₆ | 140 | C8 |
| LiClO₄ | 150 | C9 |

As shown in Table 3, internal resistance of batteries C1˜C3 wherein a lithium perfluoroalkylsulfonyl imide was used as the solute is especially small, and the batteries have superior battery characteristics after reflow treatment.

### EXPERIMENT 4

### Example 4-1

A battery D1 was prepared in the same manner as in Example 1-1 (battery A1).

### Example 4-2

A battery D2 of the present invention was prepared in the same manner as in Example 1-1 except that triethylene glycol dimethyl ether (Tri-DME) was used as the nonaqueous solvent.

### Example 4-3

A battery D3 of the present invention was prepared in the same manner as in Example 1-1 except that tetraethylene glycol dimethyl ether (Tetra-DME) was used as the nonaqueous solvent.

### Example 4-4

A battery D4 of the present invention was prepared in the same manner as in Example 1-1 except that diethylene glycol diethyl ether (Di-DEE) was used as the nonaqueous solvent.

### Example 4-5

A battery D5 of the present invention was prepared in the same manner as in Example 1-1 except that triethylene glycol diethyl ether (Tri-DEE) was used as the nonaqueous solvent.

### Example 4-6

A battery D6 of the present invention was prepared in the same manner as in Example 1-1 except that a mixture of diethylene glycol dimethyl ether (Di-DME) and propylene carbonate (PC) in a ratio of 80:20 by volume was used as the nonaqueous solvent.

### Example 4-7

A battery D7 of the present invention was prepared in the same manner as in Example 1-1 except that a mixture of diethylene glycol dimethyl ether (Di-DME) and 1,2-dimethoxy ethane (DME) in a ratio of 80:20 by volume was used as the nonaqueous solvent.

### Example 4-8

A battery D8 of the present invention was prepared in the same manner as in Example 1-1 except that propylene carbonate (PC) was used as the nonaqueous solvent.

### Example 4-9

A battery D9 of the present invention was prepared in the same manner as in Example 1-1 except that a mixture of propylene carbonate (PC) and diethyl carbonate (DEC) in a ratio of 80:20 by volume was used as the nonaqueous solvent.

### Example 4-10

A battery D10 of the present invention was prepared in the same manner as in Example 1-1 except that a mixture of propylene carbonate (PC) and 1,2-dimethoxyethane (DME) in a ratio of 80:20 by volume was used as a nonaqueous solvent.

Internal resistance after reflow of the batteries prepared above was measured in the same manner as in Example 1. The results are shown in Table 4.

TABLE 4

| Solvent (parts | | Internal Resistance | |
|---|---|---|---|
| by volume) | Solute (1 M) | after Reflow (Ω) | Battery |
| Di-DME (alone) | LiN(CF₃SO₂)₂ | 83 | D1(A1) |
| Tri-DME (alone) | LiN(CF₃SO₂)₂ | 85 | D2 |
| Tetra-DME (alone) | LiN(CF₃SO₂)₂ | 90 | D3 |
| Di-DEE (alone) | LiN(CF₃SO₂)₂ | 85 | D4 |
| Tri-DEE (alone) | LiN(CF₃SO₂)₂ | 88 | D5 |
| Di-DME/PC (80:20) | LiN(CF₃SO₂)₂ | 80 | D6 |
| Di-DME/DME (80:20) | LiN(CF₃SO₂)₂ | 88 | D7 |
| PC (alone) | LiN(CF₃SO₂)₂ | 100 | D8 |
| PC/DEC (80:20) | LiN(CF₃SO₂)₂ | 140 | D9 |
| PC/DME (80:20) | LiN(CF₃SO₂)₂ | 160 | D10 |

As is clear from the results, batteries D1˜D7 including polyethylene glycol dialkyl ether as the solvent have lower internal resistance, and have excellent battery characteristics after reflow treatment.

1. A lithium secondary battery comprising a positive electrode, a negative electrode, a separator and a nonaqueous electrolyte comprising a solute and a solvent, wherein the separator comprises a glass fiber including SiO₂, B₂O₃ and Na₂O, and the negative electrode comprises a lithium-aluminum alloy.

2. The lithium secondary battery according to claim 1, wherein the separator comprises a glass fiber including 40˜94 weight % SiO₂, 3˜30 weight % B₂O₃ and 3˜30 weight % Na₂O.

3. The lithium secondary battery according to claim 1, wherein the lithium-aluminum alloy is a lithium-aluminum-manganese alloy.

4. The lithium secondary battery according to claim 2, wherein the lithium-aluminum alloy is a lithium-aluminum-manganese alloy.

5. The lithium secondary battery according to claim 1, wherein the lithium-aluminum-manganese alloy is an alloy obtained by electrochemical insertion of lithium into an aluminum-manganese alloy including 0.1˜10 weight % manganese.

6. The lithium secondary battery according to claim 2, wherein the lithium-aluminum-manganese alloy is an alloy obtained by electrochemical insertion of lithium into an aluminum-manganese alloy including 0.1˜10 weight % manganese.

7. The lithium secondary battery according to claim 3, wherein the lithium-aluminum-manganese alloy is an alloy obtained by electrochemical insertion of lithium into an aluminum-manganese alloy including 0.1˜10 weight % manganese.

8. The lithium secondary battery according to claim 4, wherein the lithium-aluminum-manganese alloy is an alloy obtained by electrochemical insertion of lithium into an aluminum-manganese alloy including 0.1˜10 weight % manganese.

9. The lithium secondary battery according to claim 1, wherein the solute is a lithium perfluoroalkylsulfonyl imide.

10. The lithium secondary battery according to claim 2, wherein the solute is a lithium perfluoroalkylsulfonyl imide.

11. The lithium secondary battery according to claim 3, wherein the solute is a lithium perfluoroalkylsulfonyl imide.

12. The lithium secondary battery according to claim 4, wherein the solute is a lithium perfluoroalkylsulfonyl imide.

13. The lithium secondary battery according to claim 5, wherein the solute is a lithium perfluoroalkylsulfonyl imide.

14. The lithium secondary battery according to claim 6, wherein the solute is a lithium perfluoroalkylsulfonyl imide.

15. The lithium secondary battery according to claim 7, wherein the solute is a lithium perfluoroalkylsulfonyl imide.

16. The lithium secondary battery according to claim 8, wherein the solute is lithium perfluoroalkylsulfonyl imide.

17. The lithium secondary battery according to claim 1, wherein the solvent is polyethylene glycol dialkyl ether.

18. The lithium secondary battery according to claim 2, wherein the solvent is polyethylene glycol dialkyl ether.

19. The lithium secondary battery according to claim 3, wherein the solvent is polyethylene glycol dialkyl ether.

20. The lithium secondary battery according to claim 4, wherein the solvent is polyethylene glycol dialkyl ether.

21. The lithium secondary battery according to claim 5, wherein the solvent is polyethylene glycol dialkyl ether.

22. The lithium secondary battery according to claim 6, wherein the solvent is polyethylene glycol dialkyl ether.

23. The lithium secondary battery according to claim 7, wherein the solvent is polyethylene glycol dialkyl ether.

24. The lithium secondary battery according to claim 8, wherein the solvent is polyethylene glycol dialkyl ether.

25. The lithium secondary battery according to claim 9, wherein the solvent is polyethylene glycol dialkyl ether.

26. The lithium secondary battery according to claim 10, wherein the solvent is polyethylene glycol dialkyl ether.

27. The lithium secondary battery according to claim 11, wherein the solvent is polyethylene glycol dialkyl ether.

28. The lithium secondary battery according to claim 12, wherein the solvent is polyethylene glycol dialkyl ether.

29. The lithium secondary battery according to claim 13, wherein the solvent is polyethylene glycol dialkyl ether.

30. The lithium secondary battery according to claim 14, wherein the solvent is polyethylene glycol dialkyl ether.

31. The lithium secondary battery according to claim 15, wherein the solvent is polyethylene glycol dialkyl ether.

32. The lithium secondary battery according to claim 16, wherein the solvent is polyethylene glycol dialkyl ether.
